(19) United States
(12) Patent Application Publication
(10) Pub. No.: US 2004/0026806 A1
(43) Pub. Date: Feb. 12, 2004

(54) Method for producing full ceramic substructures, especially consisting of alumina, in denistry

(76) Inventor: Stefan Wolz, Bad Sobernheim (DE)

Correspondence Address: WILLIAM COLLARD, COLLARD & ROE, P.C., 1077 NORTHERN BOULEVARD, ROSLYN, NY, 11576, US

(21) Appl. No.: 10/363,344

(22) PCT Filed: Apr. 7, 2001
(86) PCT No.: PCT/EP01/04132

(30) Foreign Application Priority Data
May 8, 2000 (DE) 100 21 437.1

(51) Int. Cl. A61C 13/00

(52) U.S. Cl. 264/16

(57) ABSTRACT

The invention relates to the production of substructures, especially copings, consisting of ceramic material, preferably alumina. The stump of a work model is lined with a film or a separating agent. This lining is made electroconductive by e.g. using a metallized film or applying a silver coating. The stump is dipped in slip and a direct voltage is applied, causing the stump to be coated with an even ceramic, e.g. alumina layer which can be baked into a ceramic blank immediately after drying. The resistance of said ceramic blank is then increased by glass infiltration. Post-processing is not necessary since the ceramic material is deposited with a very even layer thickness. The inventive method is associated with a considerable saving of time in the production of a full ceramic tooth replacement.

### DESCRIPTION

A method for producing inlays, crowns and dental bridges from spinel, alumina, zirconia or similar materials is known from German patent 196 11 734. In connection with this method, a deep-drawing foil is applied to the stump of a working model, the applied foil is provided with a slicker, and the slicker present on the foil is baked after the foil has been removed from the model. The foil is baked in this process and the sintered substructure is subsequently infiltrated with glass for increasing the strength.

Furthermore, a method for producing a ceramic substructure is known from German patent 198 12 664, in which the stump of a working model is coated with a release agent that is liquid at temperatures above 45° C. and has a lipstick-like consistency at room temperature. The applied release agent is provided with a slicker and, after it has been removed from the working model, baked and infiltrated with glass as well.

In both methods, the slicker can be conventionally applied to the coating—which consists of the foil or a release agent—with a brush. In connection with a machine that has been developed by the inventor, particular good results have been obtained when the stump of the working model is dipped several times in the slicker, with drying of the applied thin layers of slicker in between. The totality of these layers of slicker results in the desired thickness of the application.

Since the finished ceramic substructure, for example in the form of a coping, had to have a uniform thickness of the coating, it was necessary to remove the excess material subsequently by milling it off on an CNC machine (see German patent 198 16 546).

Therefore, the problem of the invention specified in claim 1 is to carry out the application of the slicker in such a manner that the desired uniform thickness of the coating is obtained already with the application of the slicker.

This problem is resolved with the characterizing features of claim 1.

Advantageous implementations of the invention are described in the dependent claims.

The preparation of gold copings by galvanic deposition of gold from a gold bath (see, for example DE-A-38 05 627) is in fact already part of the prior art; however, this is a genuinely galvanic method, in connection with which the gold is present in the dissolved, complex form, which is precipitated by applying a dc voltage. The copings so prepared are in fact very true to form; however, they are not adequately stable as compared to cast copings. Furthermore, this method is too expensive for being accepted more widely. Even more disadvantageous is the fact that it is not possible with this method to produce with any ceramic copings, which are indispensable for producing a biocompatible denture.

As opposed to the prior art, the method as defined by the invention is not a galvanic method because the material, for example alumina, is not precipitated from a solution for the reason that alumina is absolutely inert.

It is assumed that the method found is based on an electrophoretic effect. However, the inventor does not wish to tie himself to a defined theory. However, the fact is that by applying a dc voltage between conventional slicker and a conductive surface, the solid matter of the slicker is precipitated as a uniform layer. It is assumed that the acid additions of the slicker are responsible for this, which support or cause the material transport.

The application of an electrophoretic method for applying an opaquer to metallic structures, in particular nobel metal structures is known from DE-A-27 05 770 as well. The supporting parts (structure, dentine and cutting compound) are produced in this process by conventional methods. As opposed to the present invention, no full ceramic denture can be produced according to DE-A-27 05 770.

The method as defined by the invention is explained in greater detail with the help of an example.

A slicker is prepared by a mixing a mixing liquid, an additive and an alumina powder according to the specification of the known InCeram method (registered trademark of the VITA Company). The stump of a working model is coated with a lipstick material (Labello=registered trademark of the firm Beiersdorf AG) by applying the release agent, which has been liquefied by heating it to above 45° C., with a brush. The release material is dyed in white with titanium dioxide in order to permit laser scanning of the contour.

After the coating has cooled off and solidified, a so-called silver lacquer is applied to this coating. Silver lacquers are known in the dental practice and mainly serve also as a material for repairing conductor boards. By applying a dc voltage of 13.6 volts between the slicker compound and the coating of the stump, which was rendered electrically conductive, an alumina layer of about 0.5 mm is deposited within 5 minutes at a current intensity of 8 A. The plus pole is applied in this connection to the stump. After drying in a drying cabinet at temperatures in excess of 100° C., the alumina coping if lifted off the working stump and subsequently sintered at 1140° C. To the extent release agent is still present after drying, it is completely burned during sintering. As the last step, the glass infiltration is carried out for increasing the strength of the ceramic structure of the coping.

The above explanations show that the method as defined by the invention is connected with considerable time savings because post-processing of the alumina coating can be dispensed with.

The coating (foil or release agent) can be made conductive by various methods. A conductive material (e.g. graphite powder or metal powder) can be admixed to the compound. However, coating the layer with a conductive coating seems to be more effective because it has a lower resistance and thus permits quicker depositing of the ceramic material. Such a coating is automatically provided if a metallized foil is used. As shown above, the release agent again can be applied in the molten condition. However, it is possible also to apply the release agent in the form of a solution, whereby the solvent is subsequently removed by evaporation.

1. A method for producing full ceramic substructures, in particular copings from alumina in dentistry, whereby the sump of a working model is coated with a foil or a release agent, a slicker is applied to said coating, and, upon separation from the working model, the slicker, after drying, is baked to the substructure, which is subsequently infiltrated with glass, characterized in that an electrically conductive coating is used, which is dipped in a vessel with slicker and the solid matter of the slicker is applied to the stump of the working model by applying a dc voltage between the vessel and the conductive coating.

2. The method according to claim 1, characterized in that if a release agent is used, the conductivity is produced by applying a silver lacquer.

3. The method according to claim 1, characterized in that if a release agent is used, the conductivity is produced by admixing a conductive material to the release agent.

4. The method according to claim 1, characterized in that if a foil is used, said foil is coated with metal.
